(19) United States
(12) Patent Application Publication
(10) Pub. No.: US 2017/0301275 A1
(43) Pub. Date: Oct. 19, 2017

(54) DISPLAY DEVICES CAPABLE OF ADJUSTING THE DISPLAY COLOR GAMUT AND METHODS OF ADJUSTING THE COLOR GAMUT THEREOF

(71) Applicant: HUIZHOU TCL MOBILE COMMUNICATION CO., LTD., Huizhou City, Guangdong Province (CN)

(72) Inventors: RUI WANG, Huizhou City, Guangdong Province (CN); XIAOQING WANG, Huizhou City, Guangdong Province (CN)

(73) Assignee: Huizhou TCL Mobile Communication Co., Ltd., Huizhou City, Guangdong Province (CN)

(21) Appl. No.: 15/322,449

(22) PCT Filed: Aug. 9, 2016
(86) PCT No.: PCT/CN2016/094065

§ 371 Date: Dec. 27, 2016

(30) Foreign Application Priority Data
Oct. 9, 2015 (CN) 201510649438.7

(51) Int. Cl. G09G 3/20; H04N 1/60; H04N 9/67

(52) U.S. Cl. CPC G09G 3/2092; H04N 9/67; H04N 1/6063; G09G 2320/0613; G09G 2320/0666; G09G 2320/0242; G09G 2340/06

(57) ABSTRACT

Display devices capable of adjusting the color gamut and methods of adjusting the color gamut thereof are disclosed. A method includes: obtaining a mapping table that comprises mapping relations between a plurality of application scenarios and a plurality of color gamut modes; obtain a current application scenario and the corresponding color gamut mode of the current application scenario from the mapping table, and adjusting the display screen to the corresponding color gamut mode of the current application scenario. Thus, the present disclosure can base on different application scenarios to automatically apply the corresponding color gamut modes, ensuring the user a plurality of color experiences and improving the experience effect of the users.

### TECHNICAL FIELD

Embodiments of the present disclosure relate generally to display color gamut technology, and in particular to display devices capable of adjusting the display color gamut and methods of adjusting the color gamut thereof.

### BACKGROUND

As display technologies continue to evolve, the wide color gamut (WCG) technology has become increasingly mature and the color gamut of a variety of display screens are becoming increasingly wider. In terms of either the liquid crystal display (LCD) or AMOLED (Active-matrix organic light-emitting diode) technology, the color gamut they produce can reach 130% of the sRGB (standard Red Green Blue) color gamut. WCG features bright colors and enhanced outdoor visibility, while sRGB has the capability of presenting true color pictures. In addition, customers can also customize the color gamut to achieve brand color characteristics, such as the sole optimization of green. However, methods in the prior art for adjusting the color gamut failed to apply different color gamut modes based on different scenarios.

### SUMMARY

In view of the above, the present disclosure provides display devices capable of adjusting the display color gamut and methods of adjusting the color gamut thereof.

There is provided a method of adjusting the color gamut of a display screen, the method comprising;

obtaining a mapping table that comprises mapping relations between a plurality of application scenarios and a plurality of color gamut modes, where the plurality of application scenarios are classified into multiple groups each corresponding to one color gamut mode;

obtaining a current application scenario and the corresponding color gamut mode of the current application scenario based on the mapping table, and adjusting the display to the corresponding color gamut mode of the current application scenario;

wherein adjusting the display to the corresponding color gamut mode of the current application scenario may comprise:

converting a digital image with a current color gamut to a color space;

obtaining in the color space a transformation matrix based on the current color gamut;

preprocessing a current image in the corresponding color gamut mode of the current application scenario and converting the processed image to the color space;

computing and processing the current image converted to the color space with the transformation matrix, so as to apply the corresponding color gamut mode of the current application scenario on the display screen.

The plurality of groups of application scenarios may comprise a first group, a second group, and a third group, where the first group may correspond to sRGB color gamut, the second group may correspond to Adobe RGB color gamut, and the third group may correspond to a customized color gamut.

Obtaining the corresponding color gamut mode of the current application scenario based on the mapping table may comprise:

if the current application scenario is a browser, obtaining the sRGB color gamut corresponding to the first group;

if the current application scenario is a professional photo, obtaining the Adobe RGB color gamut corresponding to the second group; and

if the current application scenario is a customized scenario, obtaining the customized color gamut mode corresponding to the third group.

There is also provided another method of adjusting the color gamut of a display screen, the method comprising:

obtaining a mapping table that comprises mapping relations between a plurality of application scenarios and a plurality of color gamut modes; and

obtaining a current application scenario and the corresponding color gamut mode of the current application scenario based on the mapping table, and adjusting the display screen to the corresponding color gamut mode of the current application scenario.

Adjusting the display screen to the corresponding color gamut mode of the current application scenario may comprise:

converting a digital image with a current color gamut to a color space;

obtaining in the color space a transformation matrix based on the current color gamut;

preprocessing a current image in the corresponding color gamut mode of the current application scenario and converting the processed image to the color space;

computing and processing the current image converted to the color space with the transformation matrix, so as to apply the corresponding color gamut mode of the current application scenario on the display screen.

Obtaining the mapping table that comprises the mapping relations between the plurality of application scenarios and color gamut modes may comprise:

obtaining the mapping table in which the plurality of application scenarios may be classified into a plurality of groups each corresponding to one color gamut mode.

The plurality of groups of application scenarios may comprise a first group, a second group, and a third group, where the first group may correspond to sRGB color gamut, the second group may correspond to Adobe RGB color gamut, and the third group may correspond to a customized color gamut.

Obtaining the corresponding color gamut mode of the current application scenario based on the mapping table may comprise:

if the current application scenario is a browser, obtaining the sRGB color gamut corresponding to the first group;

if the current application scenario is a professional photo, obtaining the Adobe RGB color gamut corresponding to the second group; and

if the current application scenario is a customized scenario, obtaining the customized color gamut mode corresponding to the third group.

There is also provided a display device capable of adjusting its color gamut, the display device comprising a processor, a memory, a bus, and a display screen, where the processor, memory, and display screen are coupled to the bus, respectively;

wherein the memory may be configured to store a mapping table that comprises mapping relations between a plurality of application scenarios and a plurality of color gamut modes; and the processor may be configured to: obtain a current application scenario and the mapping table, and further obtain the corresponding color gamut mode of the current application scenario based on the mapping table; and adjust the display screen to the corresponding color gamut mode of the current application scenario.

The processor may be configured to convert a digital image with the current color gamut to a color space, and obtain in the color space a transformation matrix based on the current color gamut;

preprocess a current image in the corresponding color gamut mode of the current application scenario and convert the processed image to the color space; and

compute and process the current image converted to the color space with the transformation matrix, so as to apply the corresponding color gamut mode of the current application scenario on the display screen.

The processor may be configured to classify the plurality of application scenarios into a plurality of groups and map each group to one color gamut mode.

The plurality of groups of application scenarios may comprise a first group, a second group, and a third group, where the first group may correspond to sRGB color gamut, the second group may correspond to Adobe RGB color gamut, and the third group may correspond to a customized color gamut.

If the current application scenario is a browser, the processor is configured to obtain the sRGB color gamut corresponding to the first group; if the current application scenario is a professional photo, the processor is configured to obtain the Adobe RGB color gamut corresponding to the second group; and if the current application scenario is a customized scenario, the processor is configured to obtain the customized color gamut mode corresponding to the third group.

According to the Summary of the disclosure, a mapping table that comprises the mapping relations between a plurality of application scenarios and a plurality of color gamut modes can first be obtained, then the color gamut mode corresponding to the current application scenario is obtained from the mapping table, so that the display screen can be adjusted to the corresponding color gamut mode of the current application scenario. Thus, the display device according to the disclosure can automatically match the corresponding color gamut mode based on different application scenarios, ensuring the users a variety of color experiences and improving the experience effect of the users.

### BRIEF DESCRIPTION OF THE DRAWINGS

FIG. 1 is a schematic diagram showing the corresponding spectrum loci of the color gamuts.

FIG. 2 is a flowchart illustrating a first embodiment of a method of adjusting the color gamut according to the disclosure.

FIG. 3 is a block diagram illustrating a first embodiment of a display device capable of adjusting its color gamut according to the disclosure.

### DETAILED DESCRIPTION

Hereinafter, technical implementations of the disclosure will be described in definite and comprehensive details with reference to the accompanying drawings. Obviously, the embodiments described herein are only some but not all the embodiments of the disclosure. All other embodiments derived by those of ordinary skill in the art based on the embodiments of the disclosure without making inventive efforts shall all fall in the scope of the disclosure.

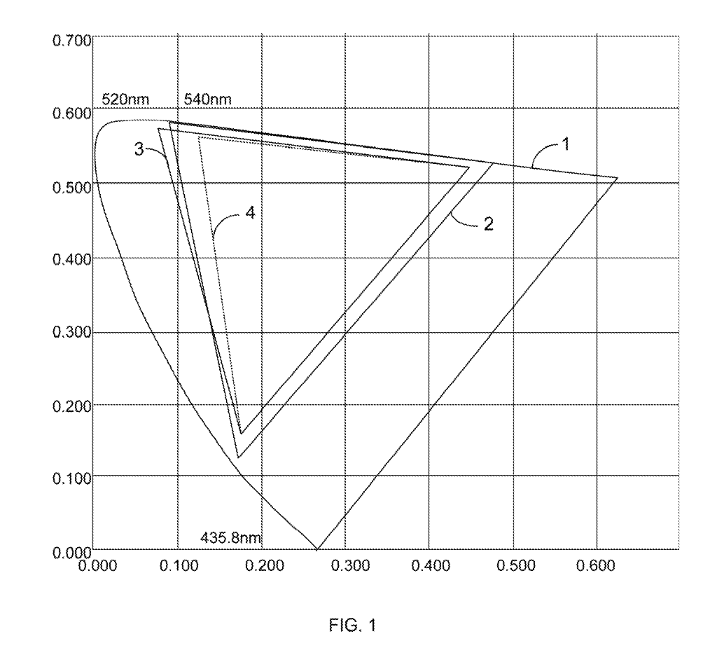

A variety of display technologies for display devices are developing rapidly. For example, smart phones have gained increasingly stronger performance in color reproduction. The current LCD display technology can with the use of improved LED backlighting and filters achieve the color gamut level of AMOLED, such as 100% of the NTSC color gamut in the CIE1931 color space. In contrast, the sRGB color gamut accounts for merely 71% of the NTSC color gamut. As shown in FIG. 1, in which the horseshoe enclosed by the spectrum locus 1 covers the entire range of human color perception; the High NTSC color gamut covers the widest color gamut that current display devices can reproduce, as shown by the spectrum locus 2 in FIG. 1, and encompasses the sRGB color gamut and substantially the Adobe RGB color gamut (the Adobe RGB color space). Adobe RGB, also a color standard, has a color space larger than that of sRGB, and is applied into some fields of the professional photo. The spectrum locus 3 shown in FIG. 1 illustrates the Adobe RGB color gamut. In comparison, the spectrum locus 4 shown in FIG. 1 illustrates the sRGB color gamut. In addition, within the High NTSC color gamut, the display device can be customized with a specific shape of color gamut, e.g., a particular color can be separately optimized.

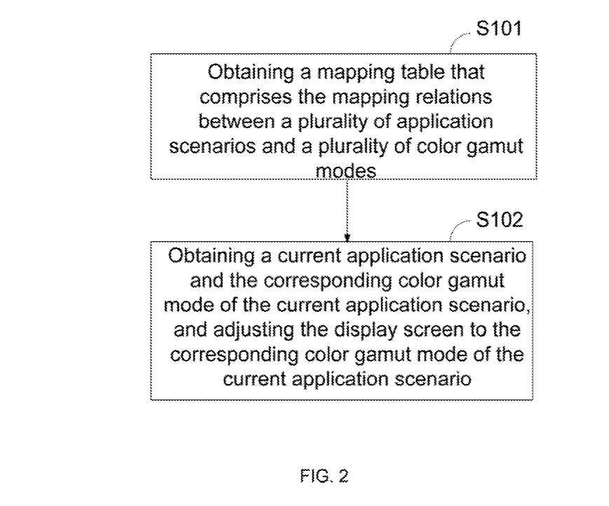

Referring now to FIG. 2, a flowchart illustrating a first embodiment of a method of adjusting the color gamut according to the disclosure is depicted. The method can be used to adjust the color gamut of the display screen of a display device, the method comprising the following blocks.

In S101, the method may include obtaining a mapping table that comprises mapping relations between a plurality of application scenarios and a plurality of color gamut modes.

In S102, the method may include obtaining a current application scenario and the corresponding color gamut mode of the current application scenario based on the mapping table, and adjusting the display screen to the corresponding color gamut mode of the current application scenario.

Before S101, the display device may preset and save the mapping table. Then, the display device can obtain the mapping table that comprises the mapping relations between the plurality of application scenarios and the plurality of color gamut modes. Typically, the display device may classify the plurality of application scenarios into multiple groups each corresponding to one color gamut mode.

Hereinafter, the present embodiment will be described in greater detail in which the application scenarios are divided into three groups including a first group A, a second group B, and a third group C. The first group A may correspond to the sRGB color gamut, the second group B may correspond to the Adobe RGB color gamut, and the third group C may correspond to a customized color gamut. The mapping table is illustrated in the following Table 1:

TABLE 1
Mapping Table

| Group | Color Gamut Mode |
|---|---|
| First group A | sRGB |
| Second group B | Adobe RBG |
| Third group C | Customized color gamut mode |

In other embodiments, those persons of ordinary skill in the art can certainly set the plurality of group as any other number (e.g., 5) of groups.

Specifically, in S102, the display device may obtain its current application scenario and the corresponding color gamut mode of the current application scenario from the mapping table, and adjust the display screen to the corresponding color gamut mode of the current application scenario. In particular, the display device adjusting the display screen to the corresponding color gamut mode of the current application scenario may comprise:

converting, by the display device, a digital image with a current color gamut to a color space;

obtaining, by the display device, in the color space a transformation matrix based on the current color gamut;

preprocessing, by the display device, a current image in the corresponding color gamut mode of the current application scenario and converting the processed image to the color space; and

computing and processing, by the display device, the current image converted to the color space with the transformation matrix, so as to apply the corresponding color gamut mode of the current application scenario on the display screen.

In particular, adjusting the display screen to the corresponding color gamut mode of the current application scenario is a digital conversion method. Based on the color space conversion theory, to display the customized narrow color gamut (e.g., sRGB or Adobe RGB) effects on a WCG display screen, the display device may need to first convert a digital image in the current color space to a device-independent color space, that is, the display device may convert the digital image with the current color gamut to the device-independent color space, e.g., CIEXYZ color space. On the basis of this device-independent color space, the display device can base on the wide color gamut, such as, the color coordinates of the three primary colors in the O space, to obtain a transformation matrix. In other words, the display device can obtain a transformation matrix, e.g., transformation matrix H, based on the current color gamut.

The display device may then preprocess a particular image in color space A and then convert the processed image to the CIEXYZ space, that is, the display device may preprocess the current image in the corresponding color gamut mode of the current application scenario and convert it to the color space. Thereafter, the converted image may be computed with the transformation matrix H in the wide color gamut space O and then further processed, in order to achieve the goal of displaying the color space A effects using the display hardware of the color space O. Namely, the display device may compute and process the current image that has been converted to the color space with the transformation matrix, to apply the corresponding color gamut mode of the current application scenario on the display screen.

The display device obtaining the corresponding color gamut mode of the current application scenario from the mapping table 1 may comprise the following.

If the current application scenario is a browser, then the display device may obtain from the mapping table 1 the sRGB color gamut corresponding to the first group A. In particular, since most pictures or images displayed in the browser use the sRGB standard, the display device may adjust the display screen to the sRGB color gamut so that pictures or images can be displayed in the browser without distortion.

If the current application scenario is a professional photo, then the display device may obtain from the mapping table 1 the Adobe RGB color gamut corresponding to the second group B. Because professional photos typically use the Adobe RGB format, the display device may adjust the display screen to the Adobe RGB color gamut so that professional photos can be displayed with richer levels.

If the current application scenario is a customized scenario, then the display device may obtain from the mapping table 1 the customized color gamut mode corresponding to the third group C. Because the user-defined image contents may be relatively large in quantity hence suitable for a bright mode, the display device may thus adjust the display screen to the customized color gamut mode.

According to the present embodiment, the display device may first obtain the current application scenario and the corresponding color gamut mode of the current application scenario, and further adjust the display screen to the corresponding color gamut mode of the current application scenario. Thus, by the present disclosure the corresponding color gamut modes can be automatically applied based on different application scenarios, ensuring the user different color experiences and improving the experience effect of the users.

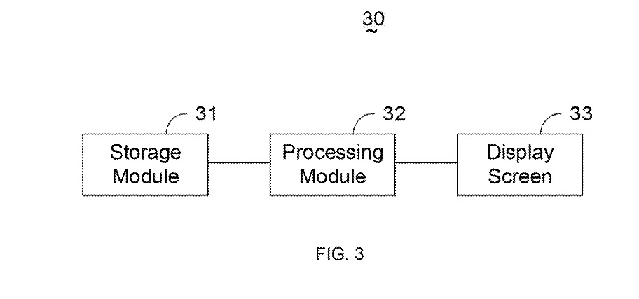

Referring now to FIG. 3, a block diagram of a display device capable of adjusting its color gamut is depicted. The display device 30 may comprise a storage module 31, a processing module 32, and a display screen 33, where the storage module 31 and the display screen 33 are coupled to the processing module 32, respectively.

The processing module 32 may be configured to preset a mapping table, and the storage module 31 may be configured to store the mapping table. The mapping table may comprise the mapping relations between a plurality of application scenarios and a plurality of color gamut modes. Typically, the processing module 32 may be configured to divide the plurality of application scenarios into multiple groups each corresponding to one color gamut mode.

The processing module 32 may be configured to obtain the mapping table from the storage module 31, obtain the current application scenario of the display device 30, and further obtain the corresponding color gamut mode of the current application scenario based on the mapping table. The processing module 32 may further be configured to adjust the display screen 33 to the color gamut corresponding to the current application scenario.

Below the present embodiment will be described in greater detail in which the application scenarios are divided into three groups including a first group A, a second group B, and a third group C. The first group A may correspond to the sRGB color gamut, the second group B may correspond to the Adobe RGB color gamut, and the third group C may correspond to a customized color gamut. The mapping table is illustrated in the above Table 1.

The processing module 32 being configured to adjust the display screen 33 to the color gamut corresponding to the current application scenario may specifically comprise:

converting, by the processing module 32, a digital image with the current color gamut to a color space;

obtaining, by the processing module 32, in the color space a transformation matrix based on the current color gamut;

preprocessing, by the processing module 32, a current image in the corresponding color gamut mode of the current application scenario and converting the processed image to the color space; and

computing and processing, by the processing module 32, the current image converted to the color space with the transformation matrix, so as to apply the corresponding color gamut mode of the current application scenario on the display screen 33.

In particular, adjusting by the processing module 32 the display screen 33 to the corresponding color gamut mode of the current application scenario is a digital conversion method. Based on the color space conversion theory, to display the customized narrow color gamut (e.g., sRGB or Adobe RGB) effects on a wide color gamut display screen, the processing module 32 may need to first convert a digital image in the current color space to a device-independent color space, that is, the processing module 32 may convert the digital image with the current color gamut to the color space, e.g., CIEXYZ color space. On the basis of this device-independent color space, the processing module 32 can base on the color coordinates of the three primary colors in the wide color gamut (e.g., O) space, to obtain a transformation matrix. In other words, the processing module 32 can obtain a transformation matrix, e.g., transformation matrix H, based on the current color gamut.

The processing module 32 may then preprocess a particular image in color space A and then convert the processed image to the CIEXYZ space, that is, the processing module 32 may preprocess the current image in the corresponding color gamut mode of the current application scenario and convert it to the color space. Thereafter, the converted image may be computed with the transformation matrix H in the wide color gamut space O and then further processed, in order to achieve the goal of displaying the color space A effects using the display screen 33 of the color space O. Namely, the processing module 32 may compute and process the current image that has been converted to the color space with the transformation matrix, so that the corresponding color gamut mode of the current application scenario can be applied on the display screen 33.

The processing module 32 obtaining the corresponding color gamut mode of the current application scenario from the mapping table 1 may comprise the following.

If the current application scenario is a browser, then the processing module 32 may obtain from the mapping table 1 the sRGB color gamut corresponding to the first group A. In particular, since most pictures or images displayed in the browser use the sRGB standard, the processing module 32 may adjust the display screen 33 to the sRGB color gamut so that pictures or images can be displayed in the browser without distortion.

If the current application scenario is a professional photo, then the processing module 32 may obtain from the mapping table 1 the Adobe RGB color gamut corresponding to the second group B. Because professional photos typically use the Adobe RGB format, the processing module 32 may adjust the display screen 33 to the Adobe RGB color gamut so that the professional photos can be displayed with richer levels.

If the current application scenario is a customized scenario, then the processing module 32 may obtain from the mapping table 1 the customized color gamut mode corresponding to the third group C. Because the user-defined image contents may be relatively large in quantity hence suitable for a bright mode, the processing module 32 may thus adjust the display screen 33 to the customized color gamut mode.

A display device capable of adjusting its color gamut is further provided that comprises a processor, a memory, a bus, and a display screen, where the processor, memory, and display screen are coupled to the bus, respectively.

The memory may be configured to store a plurality of programs and a mapping table that comprises the mapping relations between a plurality of application scenarios and a plurality of color gamut modes. The processor may be configured to obtain the current application scenario and the corresponding color gamut mode of the current application scenario from the mapping table, and adjust the display to the corresponding color gamut mode of the current application scenario.

Specifically, the processor may be configured to: convert a digital image with the current color gamut to a color space, and obtain in the color space a transformation matrix based on the current color gamut; preprocess a current image in the corresponding color gamut mode of the current application scenario and convert the processed image to the color space; compute and process the current image converted to the color space with the transformation matrix, so as to apply the corresponding color gamut of the current application scenario on the display screen.

Specifically, the processor may be configured to classify the plurality of application scenarios into a plurality of groups and map each group to one color gamut mode. Typically, the plurality of groups of application scenarios may comprise a first group, a second group, and a third group, where the first group may correspond to the sRGB color gamut, the second group may correspond to the Adobe RGB color gamut, and the third group may correspond to a customized color gamut.

If the current application scenario is a browser, the processor may be configured to obtain the sRGB color gamut corresponding to the first group; if the current application scenario is a professional photo, the processor may be configured to obtain the Adobe RGB color gamut corresponding to the second group; and if the current application scenario is a customized scenario, the processor may be configured to obtain the customized color gamut mode corresponding to the third group.

In summary, the present disclosure can base on different application scenarios to automatically apply the corresponding color gamut modes, ensuring the user a plurality of color experiences, thus improving the user experience.

The above description depicts merely some exemplary embodiments of the disclosure, but is not intended to limit the scope of the disclosure. Any equivalent structure or flow transformations made to the disclosure, or any direct or indirect applications of the disclosure on any other related fields, shall all be covered in the scope of the disclosure.

1. A method of adjusting a color gamut of a display screen, the method comprising:
obtaining a mapping table that comprises mapping relations between a plurality of application scenarios and a plurality of color gamut modes, wherein the plurality of application scenarios are classified into a plurality of groups each corresponding to one color gamut mode;
obtaining a current application scenario and the corresponding color gamut mode of the current application scenario based on the mapping table, and adjusting the display screen to the corresponding color gamut mode of the current application scenario;
wherein adjusting the display screen to the corresponding color gamut mode of the current application scenario comprises:
converting a digital image with a current color gamut to a color space;
obtaining in the color space a transformation matrix based on the current color gamut;
preprocessing a current image in the corresponding color gamut mode of the current application scenario and converting the processed current image to the color space; and
computing and processing the current image converted to the color space with the transformation matrix, so as to apply the corresponding color gamut mode of the current application scenario on the display screen.

2. The method according to claim 1, wherein the plurality of groups of application scenarios comprise a first group, a second group, and a third group, wherein the first group corresponds to sRGB color gamut mode, the second group corresponds to Adobe RGB color gamut mode, and the third group corresponds to a customized color gamut mode.

3. The method according to claim 2, wherein the obtaining the corresponding color gamut mode of the current application scenario based on the mapping table comprises:
when the current application scenario is a browser, obtaining the sRGB color gamut corresponding to the first group;
when the current application scenario is a professional photo, obtaining the Adobe RGB color gamut corresponding to the second group; and
when the current application scenario is a customized scenario, obtaining the customized color gamut mode corresponding to the third group.

4. A method of adjusting a color gamut of a display screen, the method comprising:
obtaining a mapping table that comprises mapping relations between a plurality of application scenarios and a plurality of color gamut modes; and
obtaining a current application scenario and the corresponding color gamut mode of the current application scenario based on the mapping table, and adjusting the display screen to the corresponding color gamut mode of the current application scenario.

5. The method according to claim 4, wherein the adjusting the display screen to the corresponding color gamut of the current application scenario comprises:
converting a digital image with a current color gamut to a color space;
obtaining in the color space a transformation matrix based on the current color gamut;
preprocessing a current image in the corresponding color gamut mode of the current application scenario and converting the processed image to the color space; and
computing and processing the current image converted to the color space with the transformation matrix, so as to apply the corresponding color gamut mode of the current application scenario on the display screen.

6. The method according to claim 4, wherein the obtaining the mapping table that comprises the mapping relations between the plurality of application scenarios and the plurality of color gamut modes comprises:
obtaining the mapping table in which the plurality of application scenarios are classified into a plurality of groups each corresponding to one color gamut mode.

7. The method according to claim 6, wherein the plurality of groups of application scenarios comprise a first group, a second group, and a third group, wherein the first group corresponds to sRGB color gamut mode, the second group corresponds to Adobe RGB color gamut mode, and the third group corresponds to a customized color gamut mode.

8. The method according to claim 7, wherein the obtaining the corresponding color gamut mode of the current application scenario based on the mapping table comprises:
when the current application scenario is a browser, obtaining the sRGB color gamut corresponding to the first group;
when the current application scenario is a professional photo, obtaining the Adobe RGB color gamut corresponding to the second group; and
when the current application scenario is a customized scenario, obtaining the customized color gamut mode corresponding to the third group.

9. A display device capable of adjusting its color gamut, the display device comprising a processor, a memory, a bus, and a display screen, where the processor, the memory, and the display screen are coupled to the bus, respectively;
wherein the memory is configured to store a mapping table that comprises mapping relations between a plurality of application scenarios and a plurality of color gamut modes; and
the processor is configured to: obtain a current application scenario and the mapping table, and further obtain the corresponding color gamut mode of the current application scenario based on the mapping table; and adjust the display to the corresponding color gamut mode of the current application scenario.

10. The display device according to claim 9, wherein the processor is configured to convert a digital image with a current color gamut to a color space, and obtain in the color space a transformation matrix based on the current color gamut;
preprocess a current image in the corresponding color gamut mode of the current application scenario and convert the processed image to the color space; and
compute and process the current image converted to the color space with the transformation matrix, so as to apply the corresponding color gamut mode of the current application scenario on the display screen.

11. The display device according to claim 9, wherein the processor is configured to classify the plurality of application scenarios into a plurality of groups each corresponding to one color gamut mode.

12. The display device according to claim 11, wherein the plurality of groups of application scenarios comprise a first group, a second group, and a third group, wherein the first group corresponds to sRGB color gamut mode, the second group corresponds to Adobe RGB color gamut mode, and the third group corresponds to a customized color gamut mode.

13. The display device according to claim 12, wherein when the current application scenario is a browser, the processor is configured to obtain the sRGB color gamut corresponding to the first group;
when the current application scenario is a professional photo, the processor is configured to obtain the Adobe RGB color gamut corresponding to the second group; and
when the current application scenario is a customized scenario, the processor is configured to obtain the customized color gamut mode corresponding to the third group.

14. The method according to claim 1, wherein the display screen is an LCD display or AMOLED display.

15. The method according to claim 2, wherein in the customized color gamut mode a particular color is optimized.

16. The method according to claim 4, wherein the display screen is an LCD display or AMOLED display.

17. The method according to claim 7, wherein in the customized color gamut mode a particular color is optimized.

18. The display device according to claim 9, wherein the display screen is an LCD or AMOLED display.

19. The display device according to claim 9, wherein the display device is a smartphone.

20. The display device according to claim 12, wherein in the customized color gamut mode a particular color is optimized.
